(19) United States
(12) Patent Application Publication
(10) Pub. No.: US 2025/0284578 A1
(43) Pub. Date: Sep. 11, 2025

(54) READ DISTURB SCAN IMPROVEMENT

(71) Applicant: Micron Technology, Inc., Boise, ID (US)

(72) Inventors: Yang Liu, Melissa, TX (US); Wenchi Hong, Taichung City (TW); Tingjun Xie, Milpitas, CA (US); Chao-Han Cheng, San Jose, CA (US); Aaron Lee, Sunnyvale, CA (US); Zheniel Shen, Milpitas, CA (US); Jiangli Zhu, San Jose, CA (US)

(21) Appl. No.: 19/069,979

(22) Filed: Mar. 4, 2025

Related U.S. Application Data
(60) Provisional application No. 63/561,605, filed on Mar. 5, 2024.

(51) Int. Cl. G06F 11/07

(52) U.S. Cl. CPC G06F 11/076; G06F 11/073; G06F 11/0793

(57) ABSTRACT

This disclosure configures a memory sub-system controller to dynamically perform read disturb scan operations. The controller reads data from an individual page stored on an individual memory component using a first set of read levels. The controller determines that a first error rate associated with reading the data from the individual page using the first set of read levels is greater than a first threshold. The controller reads the data from the individual page using a second set of read levels different from the first set of read levels. The controller selectively folds the individual page stored on the individual memory component based on a second error rate associated with reading the data from the individual page using the second set of read levels.

### PRIORITY APPLICATION

This application claims the benefit of priority to U.S. Provisional Application Ser. No. 63/561,605, filed Mar. 5, 2024, which is incorporated herein by reference in its entirety.

### TECHNICAL FIELD

Examples of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples.

FIGS. 2-4 are flow diagrams of example methods of performing adaptive media management operations, in accordance with some examples.

FIG. 5 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

Examples of the present disclosure configure a system component, such as a memory sub-system controller, to selectively perform one or more memory operations (e.g., folding operations) in response to read error handling (REH) conditions being satisfied for one or more memory components (e.g., memory dies). For example, the controller can determine that an REH condition is satisfied for an individual memory component. In response, the controller can read data stored in one or more memory pages of the individual memory component. If the error rate associated with the one or more memory pages transgress an error rate threshold, the controller attempts to re-read the data from the same one or more memory pages using different read levels (e.g., by adjusting the read threshold voltage levels applied when reading the data from the one or more memory pages). The controller can then perform the one or more memory operations (e.g., fold the one or more memory pages) in response to determining that reading the data using the different read levels continues to result in error rates that transgress the error rate threshold. This way, rather than always folding the data responsive to the error rate associated with reading data transgressing the threshold when the REH condition is satisfied, the controller only folds the data if multiple attempts to read the data result in the error rates that transgress the error rate threshold. This can reduce the frequency and/or number of times that folding operations are performed, which improves the overall efficiency of the memory sub-system.

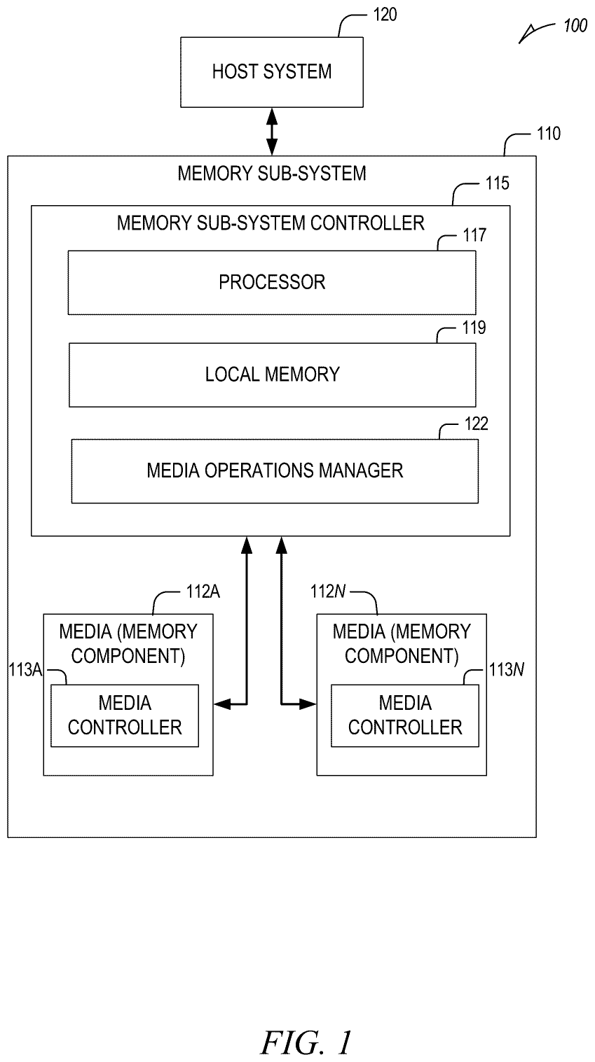

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, REH operations, different read disturb management, different near miss error correction (ECC), and/or different dynamic data refresh. Media management operations can be performed on a per die basis, per block basis, per channel basis, and/or per plane basis to compute various defectivity criteria, such as an erase status fail (ESF) indicator, a program status fail (PSF) indicator, grown bad block (GBB) information, die bad block (DBB) information, read error handling (REH) information, and/or a select gate (SG) scan fail indicator. Wear leveling ensures that all blocks in a memory component approach their defined erase-cycle budget at the same time, rather than some blocks approaching it earlier. Read disturb management counts all of the read operations performed on the memory component. If a certain threshold is reached (e.g., if the number of reads to the memory component transgress a read threshold), an REH condition may be violated. In response, the surrounding regions are refreshed in performing REH operations. Near-miss ECC refreshes all data read by the application that exceeds a configured threshold of errors. Dynamic data-refresh scans read all data and identify the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., negative-and (NAND) devices), each plane is comprised of a set of physical blocks. For some memory devices, blocks are the smallest area than can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with local embedded controllers for memory management within the same memory device package.

When certain portions of the memory components of conventional memory sub-systems are kept being stressed, such as when a certain number of read operations are performed on the portions, memory management operations (e.g., folding operations) may need to be performed if the error rates associated with reading data stored in the portions transgress a threshold. Specifically, conventional memory sub-systems determine that the REH condition for a memory component has been satisfied. In such cases, the memory controllers check selected portions (e.g., a lower page (LP) from one or more adjacent word lines (WLs) and/or random WL) of the memory component. The controller can measure the read bit error rate (RBER) associated with reading data from the selected portions. If the RBER transgresses a threshold (e.g., the RBER is greater than a maximum RBER threshold value), the controller immediately folds the page and/or block. If the RBER fails to transgress the threshold, the controller proceeds to scan another page of the memory component.

The conventional approaches assume that the RBER associated with the LP is a good indicator of the Valley 0 (V0) health condition (e.g., the lowest valley in a tri-level cell storage mechanism). However, the RBER associated with the LP RBER results from two read levels (RL1 and RL5). Any read level misplacement can result in LP high RBER even if there is not much read disturb attack seen in V0. Since RL5 is in a narrower and higher valley, V4, it is more vulnerable to read level contamination. Incorrect placement of RL5 can result in LP high RBER. Namely, the use of a default read level computed based only on the VO is a one-size-fits all approach that can cause RBER to transgress a threshold when other measures can be taken to reduce the RBER and avoid unnecessary folding operations. In this way, the conventional memory systems are inefficient and consume unnecessary storage resources and processing resources.

Examples of the present disclosure address the above and other deficiencies by providing a memory controller that can dynamically control when data is folded from a page in the process of performing REH operations. Namely, rather than always folding data if the RBER associated with reading data from a LP transgresses a threshold (e.g., in the process of performing REH operations), the disclosed techniques attempt to re-read the data using adjusted read levels (e.g., read levels adjusted by the firmware and/or directly by the memory dies). If the error rate continues to transgress the error rate threshold, then the controller folds the data stored in the page. This reduces the number of times that folding operations are performed during REH operations and/or the frequency at which folding operations are performed, which can improve the storage and retrieval of data from the memory components and reduce errors.

In some examples, the memory controller reads data from an individual page stored on the individual memory component using a first set of read levels. The controller determines that a first error rate associated with reading the data from the individual page using the first set of read levels is greater than a first threshold. In such cases, the controller re-reads the data from the individual page using a second set of read levels different from the first set of read levels and selectively folds (or performs a set of memory operations on) the individual page stored on the individual memory component based on a second error rate associated with reading the data from the individual page using the second set of read levels.

The controller can determine that a read disturb handling (RDH) condition associated with an individual memory component of the set of memory components has been satisfied. In response to determining that the RDH condition associated with the individual memory component has been satisfied, the controller reads the data using the first set of read levels. In some cases, the RDH condition includes a read count associated with the individual memory component transgressing a read count threshold. In some cases, the individual memory component includes a memory die and the read count is computed based on a number of read operations performed on the memory die.

The controller can determine that the second error rate associated with reading the data from the individual page using the second set of read levels is greater than a second threshold. In such cases, the controller, in response to determining that the second error rate associated with reading the data from the individual page using the second set of read levels is greater than the second threshold, folds the individual page. In some examples, the controller determines that the second error rate associated with reading the data from the individual page using the second set of read levels is less than a second threshold. In response, the controller prevents folding the individual page. The second threshold can be the same as or different from the first threshold.

In some cases, the controller adjusts one or more read levels including the first set of read levels to compute the second set of read levels. The one or more read levels can be adjusted by auto read calibration (ARC) operations performed by the individual memory component. The one or more read levels can be adjusted by one or more memory operations performed by the processing device of the memory sub-system. In some examples, the one or more memory operations include a block family error avoidance (BFEA) bin search.

The individual page can include a lower page in a tri-level cell (TLC) storage mechanism. In some cases, the controller stores a list of BFEA bins, each including a different read level and associated with a different index. The controller obtains the first set of read levels using read levels associated with an individual index of the list of BFEA bins and determines that one or more codewords (CW) read using the first set of read levels transgresses the first threshold. The controller re-reads data stored in the individual page using other read levels associated with one or more different indices.

In some examples, the controller computes a new index based on the individual index and an individual offset. The controller obtains the second set of read levels using read levels associated with the new index of the list of BFEA bins. The controller determines that one or more CWs read using the second set of read levels transgresses the first threshold and determines whether all offsets have been used to compute the new index. In some cases, the controller, in response to determining that all offsets have been used to compute the new index, folds the individual page.

The controller, in response to determining that less than all offsets have been used to compute the new index, selects a new offset to compute the new index based on the individual index. The new offset can be selected from a retry bin list including multiple positive and negative BFEA bin index respective to the current bin.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed. In some cases, the first memory component 112A can be implemented by a first SSD (or a first independently operable memory sub-system) and the second memory component 112N can be implemented by a second SSD (or a second independently operable memory sub-system).

In some examples, the memory sub-system 110 is a storage system. A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-systems 110. FIG. 1 illustrates one example of a host system 120 coupled to one memory sub-system 110. The host system 120 uses the memory sub-system 110, for example, to write (program) data to the memory sub-system 110 and read (retrieve) data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a USB interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components and/or storage devices. An example of non-volatile memory components include a NAND-type flash memory. Each of the memory components 112A to 112N can include one or more arrays of memory cells such as single-level cells (SLCs) or multi-level cells (MLCs) (e.g., tri-level cells (TLCs) or quad-level cells (QLCs)). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe. A single block stripe can be associated with multiple LUNs (e.g., LUN0-N).

A memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations, such as enhancement operations, different scan rates, SG scan operations, different scan frequencies, different wear leveling, different read disturb management, garbage collection operations, different near-miss ECC operations, REH operations, and/or different dynamic data refresh. The SG scan operations can be performed to test reliability of a portion or the entirety of a block stripe or portion being tested and/or one or more memory dies. The SG scan operation can apply high and/or low VT voltages to the portion being tested to determine whether the output corresponds to an expected range and/or to modify a VT of the corresponding portions. A result of the SG scan operation can be indicative of failure of the portion being tested, and if the portion fails the SG scan operation, the portion being tested and/or the entire block stripe that includes the portion being tested can be marked as bad to prevent future writes to the portion and/or block stripe.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a FPGA, an ASIC, etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include ROM for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

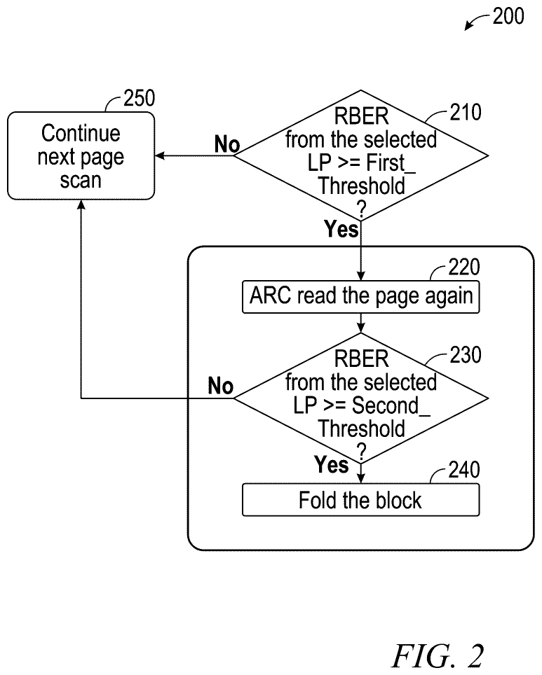

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112A to 112N. The configuration data can describe the lifetime (maximum) program-erase count (PEC) values and/or reliability grades associated with different groups of the memory components 112A to 112N and/or different blocks within each of the memory components 112A to 112N. The configuration data can also include various manufacturing information for individual memory components of the memory components 112A to 112N. The manufacturing information can specify the reliability metrics/information associated with each memory component. For example, the configuration data can specify bit error rate or RBER thresholds for controlling folding of data and/or performing read level threshold adjustments in response to REH conditions being satisfied. The configuration data can specify read count thresholds with each of the memory components 112A to 112N. When the read count threshold is reached for an individual one of the memory components 112A to 112N, the memory sub-system controller 115 can trigger or initiate the REH operations, such as those discussed below in connection with FIGS. 2-4.

Depending on the example, a media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

In some examples, the media operations manager 122 reads data from an individual page stored on an individual memory component using a first set of read levels. The media operations manager 122 determines that a first error rate associated with reading the data from the individual page using the first set of read levels is greater than a first threshold. The media operations manager 122 reads the data from the individual page using a second set of read levels different from the first set of read levels. The media operations manager 122 selectively folds (and/or performs other memory management operations in association with) the individual page stored on the individual memory component based on a second error rate associated with reading the data from the individual page using the second set of read levels.

In some examples, the commands or operations received from the host system 120 can include a write/read command, which can specify or identify an individual memory component (e.g., memory die) in which to program/read data. Based on the memory component specified by the write/read command, the memory sub-system controller 115 can program/read the data into/from one or more of the memory components 112A to 112N. The memory sub-system controller 115 can be responsible for other memory management operations, such as wear leveling operations, garbage collection operations, error detection and ECC operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the set of memory components 112A to 112N as well as convert responses associated with the set of memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the set of memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which are raw memory devices combined with a local embedded controller (e.g., local media controllers) for memory management within the same memory device package. Any one of the set of memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115. For example, a given one of the set of memory components 112A to 112N can include a media controller to perform ARC operations. The ARC operations can be executed by the media controller to identify an optimal read level for reading data from the given memory component to reduce an error rate associated with reading the data.

In some examples, the memory sub-system controller 115 can maintain a read counter or read count for each of the set of memory components 112A to 112N. The memory sub-system controller 115 can update the read counter each time one of the set of memory components 112A to 112N is read. For example, multiple read counters can be maintained each associated with a respective one of the set of memory components 112A to 112N. The memory sub-system controller 115 can determine that a first memory component of the set of memory components 112A to 112N is associated with a read counter that transgresses a read threshold value. In response, the memory sub-system controller 115 can initiate REH operations on one or more pages or blocks stored on the first memory component.

In some examples, as part of performing the REH operations, the memory sub-system controller 115 can instruct the media controller of the first memory component to perform ARC operations. Namely, the memory sub-system controller 115 can initially read a first page or first block of data from the first memory component, such as using a first set of read levels. The memory sub-system controller 115 can compute an error rate (e.g., the RBER) associated with the first page or first block of data that has been read from the first memory component. In response to determining that the error rate transgresses a first error rate threshold (as retrieved from the configuration data), the memory sub-system controller 115 can instruct the media controller of the first memory component to compute adjustments to the read levels associated with the first memory component to generate a second set of read levels.

The memory sub-system controller 115 can receive the second set of read levels from the media controller and can re-read the same first block of data or first page (e.g., the LP) from the first memory component using the second set of read levels (instead of the first set of read levels). In some cases, the media controller, as part of performing the ARC operations, re-reads the same first block of data or first page (e.g., the LP) from the first memory component. The memory sub-system controller 115 can compute an updated error rate associated with reading the data from the first memory component using the second set of read levels. The memory sub-system controller 115 can compare the updated error rate to a second error rate threshold (which can be the same as the first error rate threshold). The memory sub-system controller 115 can determine whether the updated error rate transgresses the second error rate threshold. The memory sub-system controller 115 selectively folds (or performs other memory management operations on) the data stored in the first page or first block of the first memory component based on whether the updated error rate transgresses the second error rate threshold. Namely, the memory sub-system controller 115 can fold the data in response to determining that the updated error rate transgresses the second error rate threshold. The memory sub-system controller 115 can continue to select another page without folding the first page or first block in response to determining that the updated error rate fails to transgress the second error rate threshold.

FIG. 2 is a flow diagram of an example method 200 for performing adaptive media management operations, in accordance with some examples. The method 200 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 200 is performed by the media operations manager 122 of FIG. 1 in response to the media operations manager 122 determining that an REH condition for an individual memory component (e.g., memory die) has been satisfied. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 2, the method 200 (or process) begins at operation 210, with a media operations manager 122 of a memory sub-system (e.g., memory sub-system 110) reading data from a LP of the memory component using a first set of read levels. The media operations manager 122 computes the RBER associated with reading the data from the LP and determines whether the RBER transgresses a first threshold.

Responsive to determining that reading the data from the LP results in the RBER that transgresses the first threshold, the media operations manager 122 performs operation 220, where the data is re-read from the LP using a second set of read levels generated based on performing ARC, such as by the individual memory component. The media operations manager 122 again computes the RBER and determines, at operation 230, whether the RBER transgresses a second threshold (which can be the same or different from the first threshold).

The media operations manager 122 performs operation 250 in response to determining, at operation 230, that the RBER associated with reading the data again using the second set of read levels fails to transgress the second threshold. At operation 250, the media operations manager 122 selects another page to scan and test for whether the read error rate (RBER) transgress the first/second thresholds. The media operations manager 122 performs operation 250 also in response to determining at operation 210 that the RBER associated with reading the data from the LP using the first set of read levels fails to transgress the threshold. The media operations manager 122 performs operation 240 to fold the data or perform other memory management operations in response to determining, at operation 230, that the RBER associated with reading the data again using the second set of read levels transgresses the second threshold.

In some examples, the memory sub-system controller 115 can determine that a second memory component of the set of memory components 112A to 112N is associated with a read counter that transgresses the read threshold value. In response, the memory sub-system controller 115 can initiate REH operations on one or more pages or blocks stored on the first memory component.

In some examples, as part of performing the REH operations, the memory sub-system controller 115 can leverage or use BFEA bins to find a new read level for reading data from the second memory component with minimal errors. Namely, the memory sub-system controller 115 can initially read a first page or first block of data from the second memory component, such as using a first set of read levels. The memory sub-system controller 115 can compute an error rate (e.g., the RBER) associated with the first page or first block of data (e.g., a codeword) that has been read from the second memory component. In response to determining that the error rate (bit error count) transgresses a read error rate threshold (as retrieved from the configuration data), the memory sub-system controller 115 can search for a new set of read levels to use to read the data with reduced errors. This can be done using the BFEA bins associated with the second memory component.

For example, the memory sub-system controller 115 can access a list of BFEA bins that associate different read levels with different valleys or cells of the second memory component. Each valley can be associated with a different read level. The memory sub-system controller 115 can obtain an initial index into the BFEA bins that is used to retrieve the first set of read levels that were used to read the first page or first block of data. The memory sub-system controller 115 can then access a retry bin list that specifies offsets used to adjust the initial index. The memory sub-system controller 115 can select a first offset from the retry bin list and can compute a new index by adjusting the initial index by the first offset. The memory sub-system controller 115 can obtain a second set of read levels from the BFEA bins based on the new index. The memory sub-system controller 115 can re-read the data from the first page or first block of data using the second set of read levels.

The memory sub-system controller 115 can compute an updated error rate associated with reading the data from the second memory component using the second set of read levels. The memory sub-system controller 115 can compare the updated error rate to the read error rate threshold. The memory sub-system controller 115 can determine whether the updated error rate transgresses the read error rate threshold. The memory sub-system controller 115 selectively folds (or performs other memory management operations on) the data stored in the first page or first block of the second memory component based on whether the updated error rate transgresses the read error rate threshold. Namely, the memory sub-system controller 115 can retry reading the data using another set of read levels if additional offsets remain to be tested from the retry bin list and/or can fold the data in response to determining that the updated error rate transgresses the read error rate threshold and no additional offsets remain or a maximum number of attempts to update the read levels has been reached. The memory sub-system controller 115 can continue to select another page without folding the first page or first block in response to determining that the updated error rate fails to transgress the read error rate threshold.

For example, the memory sub-system controller 115 can determine that additional offsets remain to be tested or tried from the retry bin list and that the error rate continues to transgress the read error rate threshold. In such cases, the memory sub-system controller 115 accesses the retry bin list, which specifies offsets used to adjust the initial index. The memory sub-system controller 115 can select a second offset (which can be adjacent to the first offset) from the retry bin list and can compute a new index by adjusting the initial index by the second offset. The memory sub-system controller 115 can obtain a third set of read levels from the BFEA bins based on the new index. The memory sub-system controller 115 can re-read the data from the first page or first block of data using the third set of read levels. The memory sub-system controller 115 can compute an updated error rate associated with reading the data from the second memory component using the third set of read levels. The memory sub-system controller 115 can compare the updated error rate to the read error rate threshold. The memory sub-system controller 115 can determine whether the updated error rate transgresses the read error rate threshold. The memory sub-system controller 115 selectively folds (or performs other memory management operations on) the data stored in the first page or first block of the second memory component based on whether the updated error rate transgresses the read error rate threshold. Namely, the memory sub-system controller 115 can retry reading the data using another set of read levels if additional offsets remain to be tested from the retry bin list and/or can fold the data in response to determining that the updated error rate transgresses the read error rate threshold and no additional offsets remain or a maximum number of attempts to update the read levels has been reached. The memory sub-system controller 115 can continue to select another page without folding the first page or first block in response to determining that the updated error rate fails to transgress the read error rate threshold.

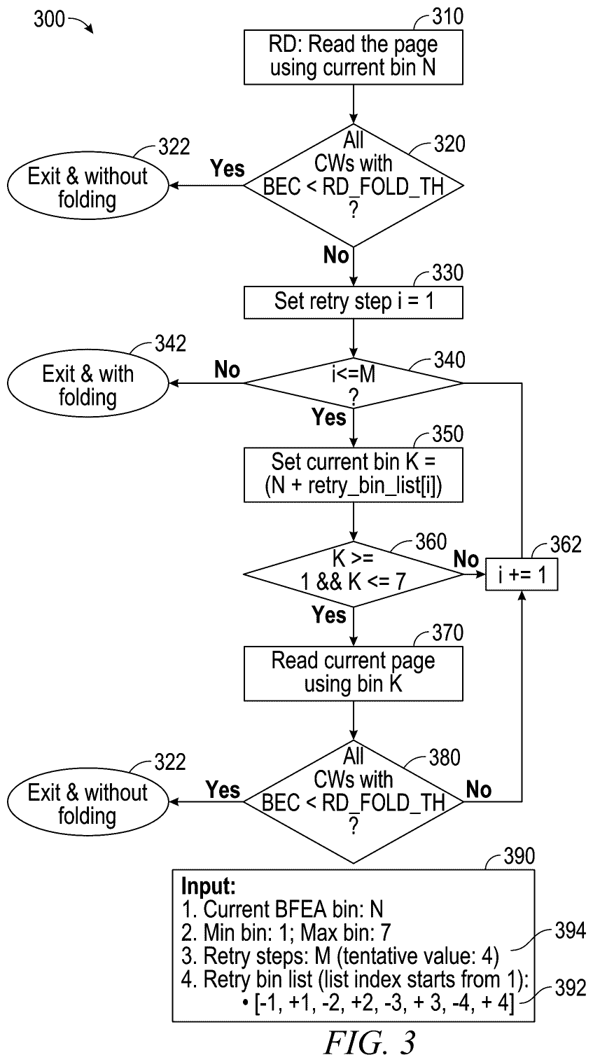

FIG. 3 is a flow diagram of an example method 300 for performing adaptive media management operations, in accordance with some examples. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 300 is performed by the media operations manager 122 of FIG. 1 in response to the media operations manager 122 determining that an REH condition for an individual memory component (e.g., memory die) has been satisfied. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 3, the method 300 (or process) begins at operation 310, with a media operations manager 122 of a memory sub-system (e.g., memory sub-system 110) reading data from a LP of the memory component using a first set of read levels, such as read levels associated with a current BFEA bin (e.g., bin N). The media operations manager 122 can obtain a set configuration data 390 including the current bin index, the number of times to retry testing different bin values or indices 394 and a bin index retry list 392. The media operations manager 122 computes the RBER associated with reading the data from the LP and determines, at operation 320, whether all the codewords (CWs) of the read data have a bit error count (BEC) that is less than a BEC threshold. Responsive to determining at operation 320 that reading the data from the LP results in all the CWs with BECs that are less than the BEC threshold, the media operations manager 122 performs operation 322, where another page is selected and folding operations are not performed on the LP that was analyzed. Responsive to determining, at operation 320, that reading the data from the LP results in one or more the CWs with BECs that are greater than the BEC threshold, the media operations manager 122 performs operation 330.

At operation 330, the media operations manager 122 performs a sequence of iterations where different bins of a set of bins of the BFEA are used to re-read data from the LP of the memory component. Namely, the media operations manager 122 accesses a maximum retry value threshold (M) (from configuration information) and sets the current retry value (i) to one at operation 330. Then, the media operations manager 122 determines whether the current retry value i transgresses the maximum retry value threshold (M) at operation 340. If so, the media operations manager 122 determines that the maximum number of attempts to read the data using different read levels has been reached and, at operation 342, folds (or performs other memory management operations on) the LP or the memory page being analyzed. If the current retry value i fails to transgress the maximum retry value threshold (M) at operation 340, the media operations manager 122 performs operation 350.

The media operations manager 122, at operation 350, computes a new bin from the set of bins of the BFEA as a function of the current BFEA bin (bin N) and a retry bin list 392. The retry bin list can specify one or more offsets that are used to recompute a new index position which can then be used to reference a particular BFEA bin. In some cases, at operation 350, the new bin index is computed by summing the current bin (e.g., the current bin index) with an offset that is determined based on the current iteration value (i). At operation 360, the media operations manager 122 determines whether the new bin is between a minimum and maximum bin value. If not, the media operations manager 122 increments the current retry value (i) at operation 362 and again performs operation 340. In response to the media operations manager 122 determining that the new bin is between the minimum and maximum bin value (stored as part of the configuration information), the media operations manager 122 performs operation 370. Namely, the media operations manager 122 re-reads the data from the LP using a second set of read levels associated with a bin of the set of BFEA bins associated with the new bin index.

At operation 380, the media operations manager 122 computes the RBER associated with reading the data from the LP using the second set of read levels and determines whether all the codewords (CWs) of the read data have a bit error count (BEC) that is less than a BEC threshold. Responsive to determining that reading the data from the LP using the second set of read levels results in all the CWs with BECs that are less than the BEC threshold, the media operations manager 122 performs operation 322, where another page is selected and folding operations are not performed on the LP that was analyzed. Responsive to determining, at operation 380, that reading the data from the LP using the second set of read levels results in one or more the CWs with BECs that are greater than the BEC threshold, the media operations manager 122 performs operation 362. Namely, the media operations manager 122 increments the current retry value (i) and again performs operation 340 to attempt to read the data using another set of read levels associated with another bin of the set of BFEA bins.

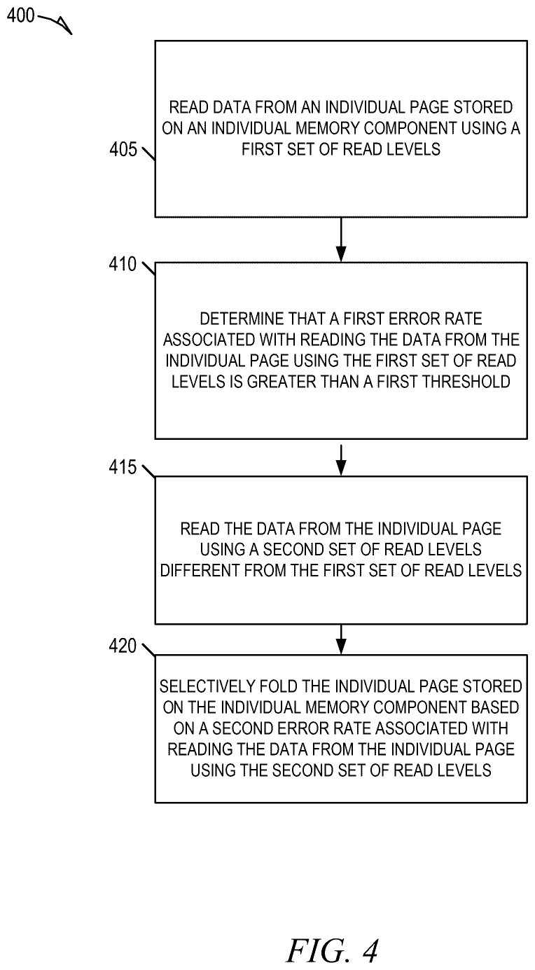

FIG. 4 is a flow diagram of an example method 400 for performing adaptive media management operations, in accordance with some examples. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 4, the method 400 (or process) begins at operation 405, with a media operations manager 122 of a memory sub-system (e.g., memory sub-system 110) reading data from an individual page stored on an individual memory component using a first set of read levels. Then, at operation 410, the media operations manager 122 determines that a first error rate associated with reading the data from the individual page using the first set of read levels is greater than a first threshold and, in response, at operation 415, reads (e.g., re-reads) the data from the individual page using a second set of read levels different from the first set of read levels. At operation 420, the media operations manager 122 selectively folds the individual page stored on the individual memory component based on a second error rate associated with reading the data from the individual page using the second set of read levels.

In view of the disclosure above, various examples are set forth below. It should be noted that one or more features of an example, taken in isolation or combination, should be considered within the disclosure of this application.

Example 1. A system comprising: a set of memory components of a memory sub-system; and at least one processing device operatively coupled to the set of memory components, the at least one processing device being configured to perform operations comprising: reading data from an individual page stored on the individual memory component using a first set of read levels; determining that a first error rate associated with reading the data from the individual page using the first set of read levels is greater than a first threshold; reading the data from the individual page using a second set of read levels different from the first set of read levels; and selectively folding the individual page stored on the individual memory component based on a second error rate associated with reading the data from the individual page using the second set of read levels.

Example 2. The system of Example 1, the operations comprising: determining that a read disturb handling (RDH) condition associated with an individual memory component of the set of memory components has been satisfied; and in response to determining that the RDH condition associated with the individual memory component has been satisfied, reading the data using the first set of read levels.

Example 3. The system of Example 2, wherein the RDH condition comprises a read count associated with the individual memory component transgressing a read count threshold.

Example 4. The system of Example 3, wherein the individual memory component comprises a memory die, the read count being computed based on read operations performed on the memory die.

Example 5. The system of any one of Examples 1-4, the operations comprising: determining that the second error rate associated with reading the data from the individual page using the second set of read levels is greater than a second threshold; and in response to determining that the second error rate associated with reading the data from the individual page using the second set of read levels is greater than the second threshold, folding the individual page.

Example 6. The system of Example 5, the operations comprising: determining that the second error rate associated with reading the data from the individual page using the second set of read levels is less than the second threshold; and in response to determining that the second error rate associated with reading the data from the individual page using the second set of read levels is less than the second threshold, preventing folding the individual page.

Example 7. The system of Example 6, wherein the second threshold comprises the first threshold.

Example 8. The system of any one of Examples 1-7, the operations comprising: adjusting one or more read levels comprising the first set of read levels to compute the second set of read levels.

Example 9. The system of Example 8, wherein the one or more read levels are adjusted by auto read calibration (ARC) operations performed by the individual memory component.

Example 10. The system of any one of Examples 8-9, wherein the one or more read levels are adjusted by one or more memory operations performed by the processing device of the memory sub-system.

Example 11. The system of Example 10, wherein the one or more memory operations comprise a block family error avoidance (BFEA) bin search.

Example 12. The system of Example 11, wherein the individual page comprises a lower page in a tri-level cell (TLC) storage mechanism.

Example 13. The system of any one of Examples 11-12, the operations comprising: storing a list of BFEA bins, each comprising a different read level and associated with a different index; obtaining the first set of read levels using read levels associated with an individual index of the list of BFEA bins; determining that one or more codewords (CW) read using the first set of read levels transgresses the first threshold; and re-reading data stored in the individual page using other read levels associated with one or more different indices.

Example 14. The system of Example 13, the operations comprising: computing a new index based on the individual index and an individual offset; obtaining the second set of read levels using read levels associated with the new index to the list of BFEA bins; determining that one or more CWs read using the second set of read levels transgresses the first threshold; and determining whether all offsets have been used to compute the new index.

Example 15. The system of Example 14, the operations comprising: in response to determining that all offsets have been used to compute the new index, folding the individual page.

Example 16. The system of any one of Examples 14-15, the operations comprising: in response to determining that less than all offsets have been used to compute the new index, selecting a new offset to compute the new index based on the individual index.

Example 17. The system of Example 16, wherein the new offset is selected from a retry bin list comprising multiple positive and negative offsets.

Methods and computer-readable storage medium with instructions for performing any one of the above Examples.

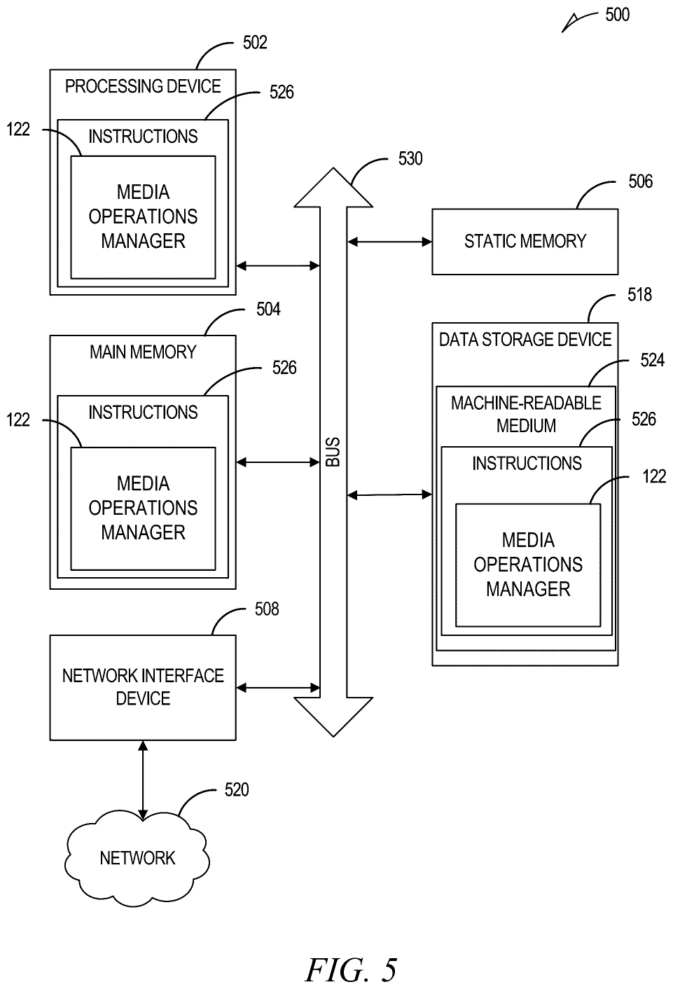

FIG. 5 illustrates an example machine in the form of a computer system 500 within which a set of instructions can be executed for causing the machine to perform any one or more of the methodologies discussed herein. In some examples, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 518, which communicate with each other via a bus 530.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an ASIC, a FPGA, a digital signal processor (DSP), a network processor, or the like. The processing device 502 is configured to execute instructions 526 for performing the operations and steps discussed herein. The computer system 500 can further include a network interface device 508 to communicate over a network 520.

The data storage device 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage device 518, and/or main memory 504 can correspond to the memory sub-system 110 of FIG. 1.

In one example, the instructions 526 implement functionality corresponding to the media operations manager 122 of FIG. 1. While the machine-readable storage medium 524 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; ROMs; RAMs; erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a ROM, RAM, magnetic disk storage media, optical storage media, flash memory components, and so forth.

In the foregoing specification, the disclosure has been described with reference to specific examples thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A system comprising:
a set of memory components of a memory sub-system; and
at least one processing device operatively coupled to the set of memory components, the at least one processing device being configured to perform operations comprising:
reading data from an individual page stored on the individual memory component using a first set of read levels;
determining that a first error rate associated with reading the data from the individual page using the first set of read levels is greater than a first threshold;
reading the data from the individual page using a second set of read levels different from the first set of read levels; and
selectively folding the individual page stored on the individual memory component based on a second error rate associated with reading the data from the individual page using the second set of read levels.

2. The system of claim 1, the operations comprising:
determining that a read disturb handling (RDH) condition associated with an individual memory component of the set of memory components has been satisfied; and
in response to determining that the RDH condition associated with the individual memory component has been satisfied, reading the data using the first set of read levels.

3. The system of claim 2, wherein the RDH condition comprises a read count associated with the individual memory component transgressing a read count threshold.

4. The system of claim 3, wherein the individual memory component comprises a memory die, the read count being computed based on read operations performed on the memory die.

5. The system of claim 1, the operations comprising:
determining that the second error rate associated with reading the data from the individual page using the second set of read levels is greater than a second threshold; and
in response to determining that the second error rate associated with reading the data from the individual page using the second set of read levels is greater than the second threshold, folding the individual page.

6. The system of claim 5, the operations comprising:
determining that the second error rate associated with reading the data from the individual page using the second set of read levels is less than the second threshold; and
in response to determining that the second error rate associated with reading the data from the individual page using the second set of read levels is less than the second threshold, preventing folding the individual page.

7. The system of claim 6, wherein the second threshold comprises the first threshold.

8. The system of claim 1, the operations comprising:
adjusting one or more read levels comprising the first set of read levels to compute the second set of read levels.

9. The system of claim 8, wherein the one or more read levels are adjusted by auto read calibration (ARC) operations performed by the individual memory component.

10. The system of claim 8, wherein the one or more read levels are adjusted by one or more memory operations performed by the processing device of the memory sub-system.

11. The system of claim 10, wherein the one or more memory operations comprise a block family error avoidance (BFEA) bin search.

12. The system of claim 11, wherein the individual page comprises a lower page in a tri-level cell (TLC) storage mechanism.

13. The system of claim 11, the operations comprising:
storing a list of BFEA bins, each comprising a different read level and associated with a different index;
obtaining the first set of read levels using read levels associated with an individual index of the list of BFEA bins;
determining that one or more codewords (CW) read using the first set of read levels transgresses the first threshold; and
re-reading data stored in the individual page using other read levels associated with one or more different indices.

14. The system of claim 13, the operations comprising:
computing a new index based on the individual index and an individual offset;
obtaining the second set of read levels using read levels associated with the new index to the list of BFEA bins;
determining that one or more CWs read using the second set of read levels transgresses the first threshold; and
determining whether all offsets have been used to compute the new index.

15. The system of claim 14, the operations comprising:
in response to determining that all offsets have been used to compute the new index, folding the individual page.

16. The system of claim 14, the operations comprising:
in response to determining that less than all offsets have been used to compute the new index, selecting a new offset to compute the new index based on the individual index.

17. The system of claim 16, wherein the new offset is selected from a retry bin list comprising multiple positive and negative offsets.

18. A method comprising:
reading data from an individual page stored on an individual memory component using a first set of read levels;
determining that a first error rate associated with reading the data from the individual page using the first set of read levels is greater than a first threshold;
reading the data from the individual page using a second set of read levels different from the first set of read levels; and
selectively folding the individual page stored on the individual memory component based on a second error rate associated with reading the data from the individual page using the second set of read levels.

19. The method of claim 18, comprising:
determining that a read disturb handling (RDH) condition associated with an individual memory component of a set of memory components has been satisfied; and
in response to determining that the RDH condition associated with the individual memory component has been satisfied, reading the data using the first set of read levels.

20. A non-transitory computer-readable storage medium comprising instructions that, when executed by at least one processing device, cause the at least one processing device to perform operations comprising:
reading data from an individual page stored on an individual memory component using a first set of read levels;
determining that a first error rate associated with reading the data from the individual page using the first set of read levels is greater than a first threshold;
reading the data from the individual page using a second set of read levels different from the first set of read levels; and
selectively folding the individual page stored on the individual memory component based on a second error rate associated with reading the data from the individual page using the second set of read levels.
